(19) United States
(12) Patent Application Publication
(10) Pub. No.: US 2026/0006446 A1
(43) Pub. Date: Jan. 1, 2026

(54) SUBSCRIBER IDENTITY MODULE SELF-INVALIDATION

(71) Applicant: T-MOBILE INNOVATIONS LLC, Overland Park, KS (US)

(72) Inventors: Kyeong Hun AN, Sammamish, WA (US); Nilesh RANJAN, Sammamish, WA (US)

(21) Appl. No.: 18/755,460

(22) Filed: Jun. 26, 2024

(51) Int. Cl. H04W 12/72; H04W 8/18; H04W 12/06

(52) U.S. Cl. CPC H04W 12/72; H04W 12/06; H04W 8/183

(57) ABSTRACT

Embodiments of the present disclosure are directed to systems and methods for self-invalidation of a subscriber identity module (SIM) in a mobile communication device. This mechanism allows the SIM to invalidate itself after detecting a predetermined number of consecutive incorrect authentication attempts, preventing unnecessary attempts to access a network. The system's operations include initiating an authentication session, receiving an authentication request from the network, and verifying the received authentication values against pre-stored values. If incorrect values are detected consecutively, the SIM increments a counter. Once the counter reaches a pre-configured threshold, the SIM updates the international mobile subscriber identity (IMSI) to a null value, rendering the SIM invalid for further use.

### SUMMARY

The present disclosure is directed, in part, to a method and system for self-invalidation of a subscriber identity module (SIM) in a mobile communication device, substantially as shown and/or described in connection with at the figures. This disclosure provides a proactive mechanism for the SIM to invalidate itself after detecting a predetermined number of consecutive incorrect authentication attempts.

According to various aspects of the technology, the disclosed method introduces a solution to the problem of unauthorized access attempts in mobile communication networks. By implementing a self-invalidation mechanism within the SIM, the disclosed method and system ensures that any SIM subjected to repeated incorrect authentication attempts is automatically rendered invalid, preventing further unauthorized access. This outcome is achieved by maintaining a counter for consecutive incorrect attempts, and upon reaching a pre-configured threshold, updating the international mobile subscriber identity (IMSI) within the SIM to a null value. This process effectively isolates the compromised or inactive SIM from the network.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an exemplary network environment in which implementations of the present disclosure may be employed; and

FIG. 4 illustrates a flow diagram of an exemplary method for self-invalidation of a subscriber identity module (SIM) in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the modern mobile communication networks rely on secure authentication protocols to validate the identity of user equipment (UE) and ensure authorized access to network services. A critical component in this process is the SIM, which stores authentication credentials and performs cryptographic operations to verify its identity to the network. Users of mobile networks frequently encounter scenarios where unauthorized attempts to access network services occur, which can compromise the integrity and security of the network.

Conventionally, when multiple incorrect authentication attempts are made, there is no immediate mechanism within the SIM to self-invalidate or signal potential compromise. This can lead to unauthorized access attempts continuing unchecked, posing a significant security risk and unnecessarily usage of network resources. In scenarios where the SIM is compromised, inactive, or under attack, the lack of a self-invalidation mechanism means that the network must rely on external monitoring and intervention, which may not be timely or efficient. The resulting vulnerability can lead to unauthorized access to network resources, data breaches, and other security incidents. Additionally, continuous attempts to access the network by an inactive device can unnecessarily use network resources that could otherwise be allocated. The conventional approach lacks a proactive, SIM-based method to halt authentication attempts and secure the device in real-time, leading to potential inefficiencies and security gaps.

In contrast to conventional solutions, the present disclosure provides a method for self-invalidation of the SIM that proactively addresses security risks associated with repeated incorrect authentication attempts. The disclosed method involves the SIM monitoring authentication attempts and maintaining a counter for consecutive incorrect attempts. When this counter reaches a pre-configured threshold, the SIM automatically updates its IMSI to a null value, effectively rendering itself invalid for further use. This self-invalidation mechanism prevents unauthorized access attempts by ensuring that a compromised SIM cannot continue to interact with the network. By integrating this method into the SIM, the invention provides an immediate and effective solution to enhance security, reduce the risk of unauthorized access, and improve overall network integrity and resource allocation.

Accordingly, a first aspect of the present disclosure provides a system for self-invalidation of a SIM in a mobile communication device. The system comprises one or more computer processing components configured to perform operations. The operations comprise first initiating, by the SIM within the mobile communication device, an authentication session with a network. The operations next comprise receiving, by the SIM, an authentication request from the network. The operations further comprise verifying, by the SIM, one or more authentication values received from the network against pre-stored authentication values. The operations additionally comprise incrementing, by the SIM, a counter when the verification of the one or more authentication values indicates an incorrect authentication, wherein the counter is incremented only when an incorrect one or more authentication values are received consecutively. The operations finally comprise determining, by the SIM, if the counter has reached a pre-configured threshold value, and in response to the counter reaching the pre-configured threshold value, updating, by the SIM, an International Mobile Subscriber Identity (IMSI) value to a null value.

A second aspect of the present disclosure provides a method for self-invalidation of a SIM in a mobile communication device. The method comprises first initiating, by the SIM within the mobile communication device, an authentication session with a network. The method next comprises receiving, by the SIM, an authentication request from the network. The method further comprises verifying, by the SIM, one or more authentication values received from the network against pre-stored authentication values. The method additionally comprises incrementing, by the SIM, a counter when the verification of the one or more authentication values indicates an incorrect authentication, wherein the counter is incremented only when an incorrect one or more authentication values are received consecutively. The method finally comprises determining, by the SIM, if the counter has reached a pre-configured threshold value, and in response to the counter reaching the pre-configured threshold value, updating, by the SIM, an IMSI value to a null value.

Another aspect of the present disclosure is directed to a non-transitory computer readable medium having instructions stored thereon that, when executed by one or more computer processing components, cause the one or more computer processing components to perform a method for self-invalidation of a SIM in a mobile communication device. The method comprises first initiating, by the SIM within the mobile communication device, an authentication session with a network. The method next comprises receiving, by the SIM, an authentication request from the network. The method further comprises verifying, by the SIM, one or more authentication values received from the network against pre-stored authentication values. The method additionally comprises incrementing, by the SIM, a counter when the verification of the one or more authentication values indicates an incorrect authentication, wherein the counter is incremented only when an incorrect one or more authentication values are received consecutively. The method finally comprises determining, by the SIM, if the counter has reached a pre-configured threshold value, and in response to the counter reaching the pre-configured threshold value, updating, by the SIM, an IMSI value to a null value.

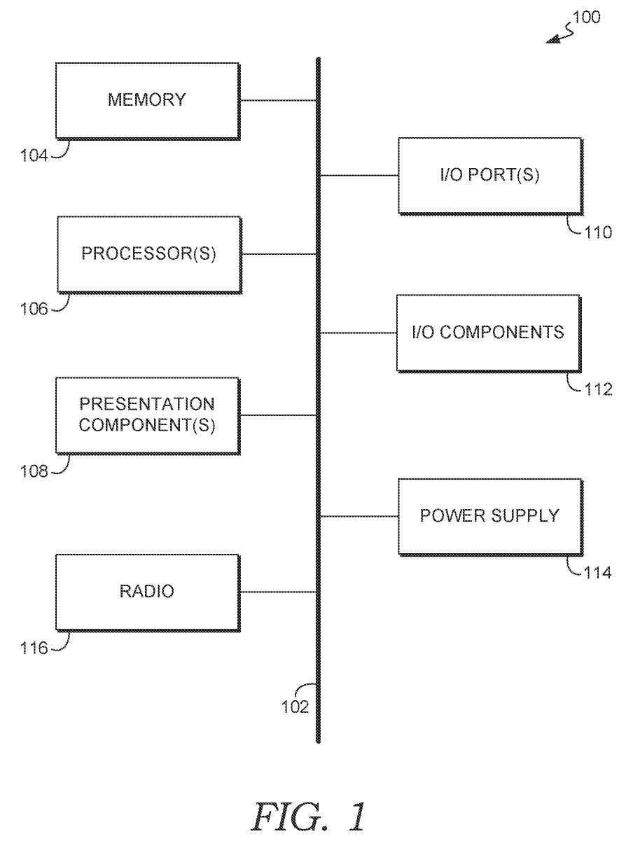

Referring to the drawings in general, and initially to FIG. 1, an exemplary computing environment 100 suitable for practicing embodiments of the present technology is provided. Computing environment 100 is just one example, and is not intended to suggest any limitation as to the scope of use or functionality of the embodiments discussed herein. Furthermore, the computing environment 100 should not be interpreted as having any dependency or requirement relating to any one or a combination of components illustrated. It should be noted that although some components in FIG. 1 are shown in the singular, they might be plural. For example, the computing environment 100 might include multiple processors and/or multiple radios. As shown in FIG. 1, computing environment 100 includes a bus 102 that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 may take the form of memory components described herein. Thus, further elaboration will not be provided here, but it should be noted that memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. Processor 106 may actually be multiple processors that receive instructions and process them accordingly. Presentation component 108 may include a display, a speaker, and/or other components that may present information (e.g., a display, a screen, a lamp (LED), a graphical user interface (GUI), and/or even lighted keyboards) through visual, auditory, and/or other tactile cues.

Radio 116 may facilitate communication with a network, and may additionally or alternatively facilitate other types of wireless communications, such as Wi-Fi, WiMAX, LTE, and/or other VoIP communications. In various embodiments, the radio 116 may be configured to support multiple technologies, and/or multiple radios may be configured and utilized to support multiple technologies. The input/output (I/O) ports 110 may take a variety of forms. Exemplary I/O ports may include a USB jack, a stereo jack, an infrared port, a firewire port, other proprietary communications ports, and the like. Input/output (I/O) components 112 may comprise keyboards, microphones, speakers, touchscreens, and/or any other item usable to directly or indirectly input data into the computing environment 100. Power supply 114 may include batteries, fuel cells, and/or any other component that may act as a power source to supply power to the computing environment 100 or to other network components, including through one or more electrical connections or couplings. Power supply 114 may be configured to selectively supply power to different components independently and/or concurrently.

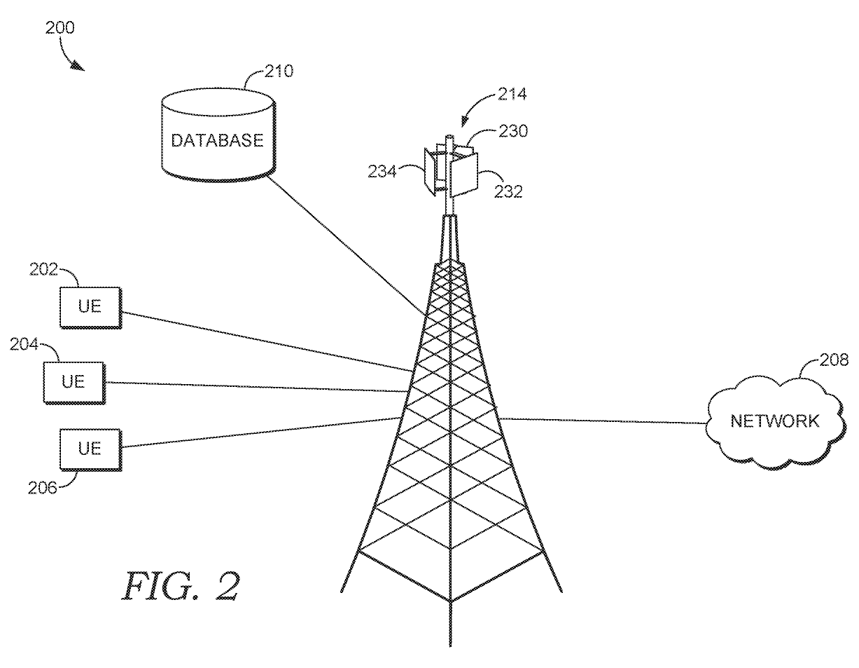

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, database 210, and dynamic mitigation engine 212. In network environment 200, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, 6G, CDMA, or any other type of network.

In In other aspects, the user devices 202, 204, and 206 encompass a diverse range of high-throughput and high data consumption devices, catering to various user needs and environments. The first device, 202, corresponds to a Home Internet Network Terminal (HINT). Device 204 represents a Fixed Wireless Access (FWA) device, which provides internet access in areas where wired connectivity is limited or unavailable.

Additionally, device 206 can be any device characterized by high data throughput needs, such as advanced gaming consoles that require rapid data exchange for real-time multiplayer experiences, or professional-grade video conferencing systems used in businesses for high-quality virtual meetings. This category also includes emerging Internet of Things (IoT) devices, like intelligent security cameras and smart home appliances, which constantly transmit and receive data for automation and monitoring purposes. Furthermore, high-performance tablets and laptops also fall under this category, as they require high-speed internet for cloud computing and large file transfers.

In some cases, the user devices 202, 204, and 206 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE, 4G, 5G, 6G) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1x circuit voice, a 3G network (e.g., CDMA, CDMA2000, WCDMA, GSM, UMTS), a 4G network (WiMAX, LTE, HSDPA), a 5G network, or a 6G network. The network 208 may also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited coverage area. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 may comprise multiple base stations and/or multiple transmit antennas for each of the one or more base stations, any one or more of which may serve at least a portion of the cell. For example, the cell site may comprise a first antenna array 230, a second antenna array 232, and a third antenna array 234, wherein each of the antenna arrays serves a distinct sector (i.e., portion) of the coverage area of the cell 214. In some aspects, the cell site 214 may comprise one or more macro cells (providing wireless coverage for users within a large geographic area) or it may be a small cell (providing wireless coverage for users within a small geographic area).

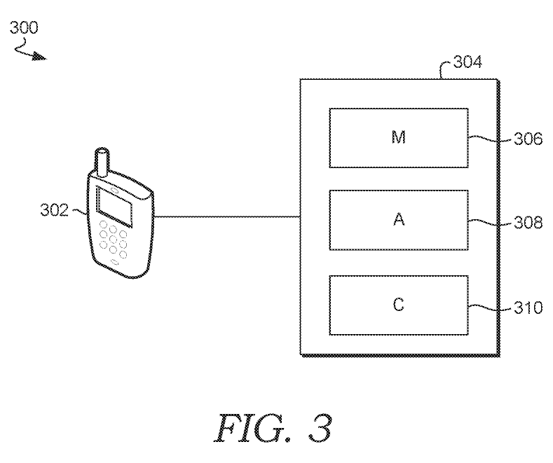

FIG. 3 provides an exemplary network environment in which implementations of the present disclosure may be employed. Such a network environment is illustrated and designated generally as network environment 300. Network environment 300 is but one example of a suitable network environment and is not intended to suggest any limitation as to the scope of use or functionality of the invention. Neither should the network environment be interpreted as having any dependency or requirement relating to any one or combination of components illustrated. The network environment 300 includes a UE 302 that is capable of operating in network environment 200. The network environment 300 additionally comprises one or more hardware and/or software components that, together, make up a SIM management engine 304. The SIM management engine 304 comprises a monitor 306, an analyzer 308, and a controller 310. The monitor 306 is generally configured to receive authentication requests from the network and verify the received authentication values against pre-stored authentication values within the SIM. The SIM could be a physical SIM, an embedded SIM (eSIM), or another authentication method used to identify and authenticate the subscriber on the network, such as a soft SIM, virtual SIM, or network-based authentication using secure credentials stored in a database or cloud.

The monitor 306 is responsible for receiving authentication requests from the network and verifying the received authentication values against pre-stored authentication values within the SIM. These authentication requests are in response to the UE 302 attempting to validate or attach to the network, such as network 208. This validation process ensures that the SIM is authorized to access the network and allows the UE 302 to establish a secure connection between the UE 302 and the network 208. During this process, the network sends authentication values to the SIM, which are then verified by the monitor 306 against the pre-stored values within the SIM.

Upon receiving an authentication request, the monitor 306 retrieves authentication values included in the request. The monitor 306 then compares these received authentication values with corresponding pre-stored authentication values in the SIM to determine their validity. The pre-stored authentication values can be stored within the SIM or in a database associated with the SIM. If the authentication values match, the authentication is considered successful, and no further action is taken. However, if the authentication values do not match, the monitor 306 increments an internal counter. This counter tracks the number of consecutive incorrect authentication attempts. In some embodiments, the counter is only incremented when incorrect authentication values are received consecutively. If a correct authentication value is received after one or more incorrect values, the counter is reset to zero. This mechanism ensures that only consecutive incorrect attempts are counted, preventing sporadic or isolated incorrect attempts from triggering unnecessary actions.

Upon detecting incorrect authentication values, the monitor 306 increments an internal counter. This counter is incremented only when consecutive incorrect authentication attempts occur, ensuring that sporadic or isolated incorrect attempts do not affect the process. The analyzer 308 is generally configured to determine if the counter has reached a pre-configured threshold value. Upon reaching this threshold, the analyzer 308 initiates the self-invalidation process by updating a value associated with the SIM. In one aspect, the IMSI value is updated to a null value, effectively rendering the SIM invalid for further use. In other aspects, the analyzer 308 is configured to update other values associated with the UE or the SIM such as an IP multimedia private identity (IMPI) or an IP multimedia public identity (IMPU) for the IP multimedia system (IMS). Other values associated with the IMS, SIM, or UE can be updated which would render the SIM invalid and are not listed but would be understood by a person skilled in the art.

The controller 310 is generally configured to manage the overall operation of the SIM management engine 304, including implementing a lockout period during which the SIM does not respond to further authentication requests after the threshold is exceeded. The controller 310 also facilitates the refreshing of the SIM or the mobile communication device and enables remote reset and secure reactivation of the SIM by the network operator after the IMSI value has been updated to the null value

The analyzer 308 determines if the counter has reached a pre-configured threshold value. The threshold value represents the maximum allowable number of consecutive incorrect authentication attempts before the SIM is considered compromised or inactive. This threshold value is configurable by the network operator and is set to balance security and usability. When the monitor 306 indicates that the counter has reached this threshold, the analyzer 308 initiates a lockout mechanism managed by the controller 310. This lockout period prevents the SIM from responding to any further authentication requests. The duration and nature of the lockout period can be configured by the network operator. In some implementations, the lockout period may be temporary, allowing the SIM to be reactivated after a certain time. In other cases, it may be permanent, requiring manual intervention or reset by the network operator.

The lockout period includes updating the IMSI value for the SIM to a null value, effectively rendering the SIM invalid for further use. The update process involves replacing the current IMSI value with a null value. The null value can be represented by a sequence of all 'FF' hexadecimal values, which is a standardized way to indicate that the IMSI is no longer valid. This null value prevents the SIM from being authenticated by the network in subsequent attempts. The null value for the IMSI further prevents the SIM and the UE 302 from attempting to attach to the network at all, effectively isolating the compromised SIM from the network and preventing any unauthorized access or attempts to access the network.

In other embodiments, the analyzer 308 can log each incorrect authentication attempt along with a timestamp and send alerts to a network operator when the threshold is reached. This logging provides a detailed record of the authentication failures, which can be used for further analysis or troubleshooting. The timestamps help in tracking the exact time of each failed attempt, providing insights into potential patterns or attacks. The alert mechanism ensures that the network operator is immediately informed of any potential security issues, allowing prompt action to secure the network and address any vulnerabilities.

The analyzer 308 and monitor 306 work in conjunction to ensure that the SIM is protected from unauthorized access attempts. By tracking and analyzing authentication failures, the system can proactively invalidate compromised SIMs, thereby enhancing the overall security of the network. This approach to SIM management helps in maintaining the integrity and reliability of mobile communication services.

The controller 310 manages the overall operation of the SIM management engine 304, including the implementation of a lockout period during which the SIM does not attempt to attach to the network or respond to further authentication requests after the threshold is exceeded. The controller 310 ensures that the lockout period is managed according to the configurations set by the network operator, including whether the lockout period is temporary or permanent. During the lockout period, the SIM remains inactive and does not participate in any authentication processes, effectively isolating the compromised SIM from the network. The controller 310 also facilitates the refreshing of the SIM or the mobile communication device, ensuring that any necessary updates or resets are performed to restore normal operation. Additionally, it enables the remote reset and secure reactivation of the SIM by the network operator after the IMSI value has been updated to the null value. This remote reset capability allows the network operator to securely reactivate and reuse the SIM without physical intervention, providing flexibility and convenience in managing the SIM's status. The resetting of the SIM includes updating the IMSI value to the original value, thus allowing the SIM to resume attempts to attach to the network 208.

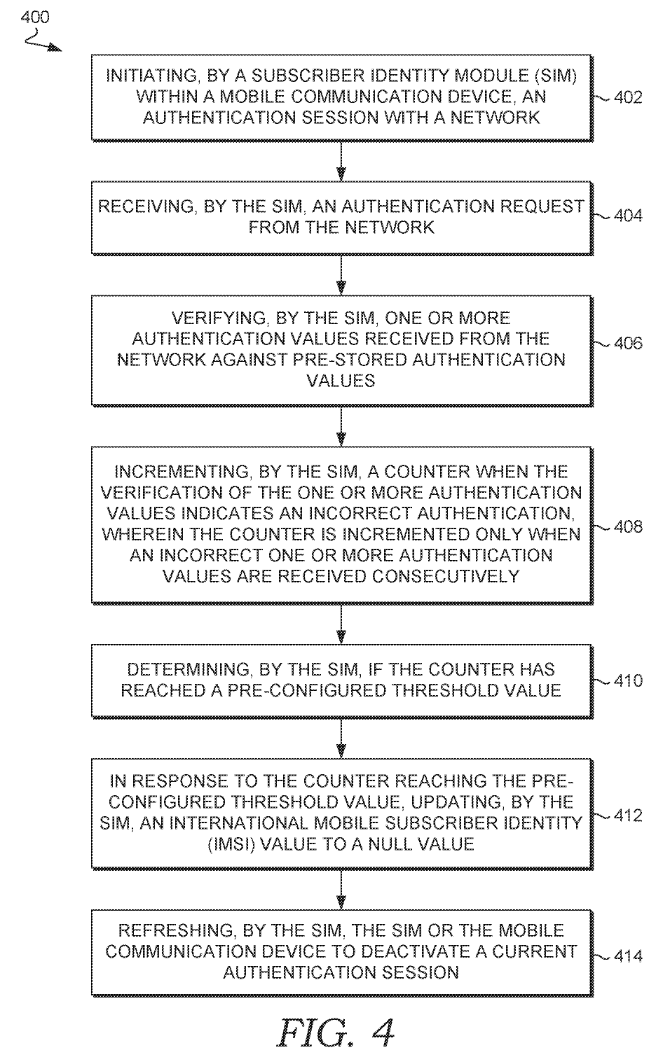

Turning now to FIG. 4, a flow chart is provided that illustrates one or more aspects of the present disclosure relating to a method 400 for self-invalidation of a SIM in a mobile communication device. The method 400 begins at block 402 with the initiation of an authentication session by the SIM within the mobile communication device with a network. This initial step involves the SIM starting the process of validating its identity and establishing a secure connection with the network. Specifically, this step entails the SIM sending an initial request to the network to commence the authentication procedure. Upon initiating the authentication session, the SIM sends its unique identifier, known as the IMSI, to the network. The network, such as network 208, then uses this IMSI to locate the corresponding authentication data stored in its database, such as database 210. Following this, the network generates a set of authentication values, which may include a random challenge (RAND), an expected response (XRES), and encryption keys (Kc).

The network transmits these authentication values to the SIM as part of an authentication request. The SIM, upon receiving this authentication request, prepares to verify its identity by utilizing its internal security algorithms and pre-stored authentication keys. The SIM uses its internal authentication algorithm, often based on cryptographic functions, to process the received RAND along with its pre-stored authentication key (Ki). The result of this cryptographic operation is the response SRES, which the SIM compares with the expected response (XRES) provided by the network. If the responses match, the SIM's identity is verified, and the network allows the device to connect.

At block 404, the SIM receives the authentication request from the network. This request includes one or more authentication values that the network uses to verify the identity of the SIM. Typically, these authentication values are part of a standard authentication procedure and include elements such as a RAND, an XRES, and potentially encryption keys (Kc).

Upon receiving the authentication request, the SIM extracts the authentication values from the message. The SIM proceeds to verify these received authentication values against pre-stored authentication values within the SIM. This involves a series of cryptographic operations performed by the SIM's internal authentication algorithms, which are based on its secret key (Ki) and other pre-stored data. Firstly, the SIM takes the received RAND value and inputs it into its authentication algorithm along with its Ki. The authentication algorithm, typically a cryptographic hash function or a similar secure algorithm, processes these inputs to generate a signaled response (SRES). This SRES is a cryptographic output unique to the combination of the RAND and Ki, ensuring that it can only be correctly generated by a SIM possessing the correct secret key.

The SIM then compares this internally SRES with the XRES provided by the network in the authentication request. The XRES is generated by the network using the same algorithm and key associated with the SIM’s IMSI stored in the network’s database. If the SRES generated by the SIM matches the XRES provided by the network, the SIM’s identity is verified. This matching process confirms that the SIM possesses the correct secret key and is therefore legitimate and authorized to access the network. The successful verification allows the SIM to proceed with establishing a secure communication session with the network, enabling normal mobile device operations such as making calls, sending messages, and using data services.

However, if the SRES does not match the XRES, the authentication attempt is considered unsuccessful. This triggers the next step in the process, where the SIM increments an internal counter to track the number of consecutive failed authentication attempts

If the verification process indicates that the authentication values do not match the pre-stored values, the SIM increments a counter at step 406. This counter tracks the number of consecutive incorrect authentication attempts. The counter is incremented only when incorrect authentication values are received consecutively, ensuring that only a series of continuous failed attempts are counted.

The method then proceeds to step 410, where the SIM determines if the counter has reached a pre-configured threshold value. This threshold value is set to represent the maximum allowable number of consecutive incorrect authentication attempts before the SIM is considered compromised or inactive. The counter, which was incremented in previous steps upon each consecutive incorrect authentication attempt, is compared to this threshold. The threshold value is predetermined and configured by the network operator based on security policies. When the SIM checks the counter against the threshold, it evaluates whether the number of failed attempts has reached a level that indicates a potential security breach or misuse of the SIM. This step is crucial as it helps in identifying when the SIM should be invalidated to prevent further unauthorized access attempts.

Upon determining that the counter has reached the pre-configured threshold value, the method moves to step 412. At this step, the SIM updates the IMSI value to a null value. The null value, which can be represented by a sequence of all 'FF' hexadecimal values, effectively renders the SIM invalid for further use. This update process involves overwriting the current IMSI stored in the SIM with the null value, ensuring that the SIM cannot be used for subsequent authentication attempts. By setting the IMSI to a null value, the SIM is prevented from establishing any connection with the network, thus blocking any unauthorized access. This measure ensures that once the SIM is deemed compromised, it is effectively isolated from the network, maintaining the security integrity of the mobile communication system.

Finally, at step 414, the SIM or the mobile communication device is refreshed to deactivate the current authentication session. This step ensures that the invalidated SIM does not continue to attempt to authenticate with the network, thereby enhancing the security of the mobile communication device and the network. Refreshing the SIM or device involves resetting the authentication session and clearing any ongoing authentication processes. This action guarantees that the SIM, now with a null IMSI value, is completely deactivated and cannot be used for further communication attempts. By deactivating the current session, the method ensures that the compromised SIM is effectively removed from the network, preventing any potential security threats and maintaining the overall integrity of the mobile communication environment.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for self-invalidation of a subscriber identity module (SIM) in a mobile communication device, the method comprising:
receiving an authentication request from a network, the authentication request comprising one or more authentication values;
comparing the one or more authentication values against one or more pre-stored authentication values;
determining that the one or more authentication values and the pre-stored authentication values do not match;
based on the determination that the one or more authentication values and the pre-stored authentication values do not match, incrementing a counter;
determining that the counter has reached a pre-configured threshold value; and
in response to the counter reaching the pre-configured threshold value, updating an international mobile subscriber identity (IMSI) value within the SIM to a null value.

2. The method of claim 1, wherein the null value for the IMSI is represented by a sequence of hexadecimal values, each hexadecimal value of the sequence of hexadecimal values comprising an FF value.

3. The method of claim 1, wherein the pre-configured threshold value for the counter is configurable by a network operator.

4. The method of claim 1, further comprising refreshing the SIM or the mobile communication device following the updating the IMSI value.

5. The method of claim 1, wherein the one or more authentication values are comprised of a challenge-response between the SIM and the network.

6. The method of claim 1, wherein the SIM stores a record of each incorrect authentication.

7. The method of claim 1, further comprising the step of sending an alert to a network operator when the counter reaches the pre-configured threshold value.

8. The method of claim 7, wherein the SIM is remotely reset by the network operator after the IMSI value has been updated to the null value.

9. The method of claim 1, wherein the counter is reset to zero after a successful authentication attempt.

10. A method for managing authentication in a mobile communication device with an embedded subscriber identity module (eSIM), the method comprising:
receiving, by the eSIM, a sequence of authentication requests from a network;
performing a verification process for each authentication request to determine if one or more authentication values match pre-stored values within the eSIM;
maintaining, by the eSIM, a record of a number of consecutive incorrect authentication attempts;
implementing a lockout period for the eSIM when the number of consecutive incorrect authentication attempts exceeds a predefined threshold; and
automatically resuming normal operation of the eSIM after the lockout period ends.

11. The method of claim 10, further comprising the step of notifying a user of the mobile communication device when the lockout period is implemented.

12. The method of claim 10, wherein the lockout period is configurable by the network operator through a remote management system.

13. The method of claim 10, wherein the lockout period is temporary.

14. The method of claim 10, wherein the lockout period is permanent.

15. The method of claim 10, wherein the lockout period comprises updating, by the eSIM, an international mobile subscriber identity (IMSI) value to a null value.

16. The method of claim 15, wherein the null value for the IMSI is represented by a sequence of hexadecimal values, each hexadecimal value of the sequence of hexadecimal values comprising an FF value.

17. A system for managing authentication of a mobile communication network using a subscriber identity module (SIM), comprising:
a SIM configured to store an international mobile subscriber identity (IMSI) and authentication keys;
a security module within the SIM configured to:
compare authentication values received from a network entity with pre-stored authentication values;
track a number of consecutive incorrect authentication attempts;
update the IMSI to a null value upon reaching a predetermined number of consecutive incorrect attempts; and
a management interface for a network operator to configure the predetermined number of consecutive incorrect attempts and monitor a status of the SIM.

18. The system of claim 17, wherein the null value for the IMSI is represented by a sequence of hexadecimal values, each hexadecimal value of the sequence of hexadecimal values comprising an FF value.

19. The system of claim 17, wherein the predetermined number of consecutive incorrect attempts is configurable by the network operator through the management interface.

20. The system of claim 17, further comprising notifying a user of a mobile communication device when the IMSI is updated to the null value.
